(19) United States
(12) Patent Application Publication
(10) Pub. No.: US 2023/0351918 A1
(43) Pub. Date: Nov. 2, 2023

(54) Training Spoon

(71) Applicant: BROOKE RENEE SANCHEZ, ESCONDIDO, CA (US)

(72) Inventor: BROOKE RENEE SANCHEZ, ESCONDIDO, CA (US)

(21) Appl. No.: 18/070,438

(22) Filed: Nov. 28, 2022

Related U.S. Application Data
(63) Continuation-in-part of application No. 29/705,933, filed on Sep. 17, 2019, now Pat. No. D970983.

(51) Int. Cl. G09B 19/24; A47G 21/04; A47G 21/02

(52) U.S. Cl. CPC G09B 19/24; A47G 21/04; A47G 21/02

(57) ABSTRACT

A training spoon for training a user on how to use a spoon. The training spoon has a scoop, a straight handle connected to the scoop and an angled handle rigidly connected to the straight handled. The straight handle is grabbable by the user and the angled handled is grabbable by the trainer while assisting the user in proper usage of the training spoon.

The present invention relates to training devices, and in particular, to training devices for training the user in proper usage of eating utensils. The present invention is a Continuation-in-Part (CIP) of U.S. patent application Ser. No. 29/705,933, filed on Sep. 17, 2019, all of which is incorporated by reference herein.

### BACKGROUND OF THE INVENTION

The spoon is a common object that is held in the hand and used to lift solids and liquids to be consumed by the user. Children who are learning to use utensils often have problems grasping, holding and maneuvering regular adult sized spoons. Also, the hard material used to make regular spoons can be harmful when used by young children. Therefore, softer material spoons are available for toddlers or very young children. Although there are a variety of spoons available, the prior art is lacking when it comes to providing spoons that allow a parent or helper to assist the spoon user in proper spoon usage.

What is needed is a better spoon that allows for a second person to help the spoon user in proper spoon usage.

### SUMMARY OF THE INVENTION

The present invention provides a training spoon for training a user on how to use a spoon. The training spoon has a scoop, a straight handle connected to the scoop and an angled handle rigidly connected to the straight handled. The straight handle is grabbable by the user and the angled handled is grabbable by the trainer while assisting the user in proper usage of the training spoon.

### BRIEF DESCRIPTION OF THE DRAWINGS

FIG. 1 shows a perspective view of a preferred embodiment of the present invention.

FIG. 2 shows a front view of a preferred embodiment of the present invention.

FIG. 3 shows a rear view of a preferred embodiment of the present invention.

FIG. 4 shows a top view of a preferred embodiment of the present invention.

FIG. 5 shows a bottom view of a preferred embodiment of the present invention.

FIGS. 6 and 7 shows side views of a preferred embodiment of the present invention.

FIG. 8 shows another preferred embodiment of the present invention.

FIGS. 9 and 10 show the utilization of preferred embodiments of the present invention.

### DETAILED DESCRIPTION OF THE PREFERRED EMBODIMENTS

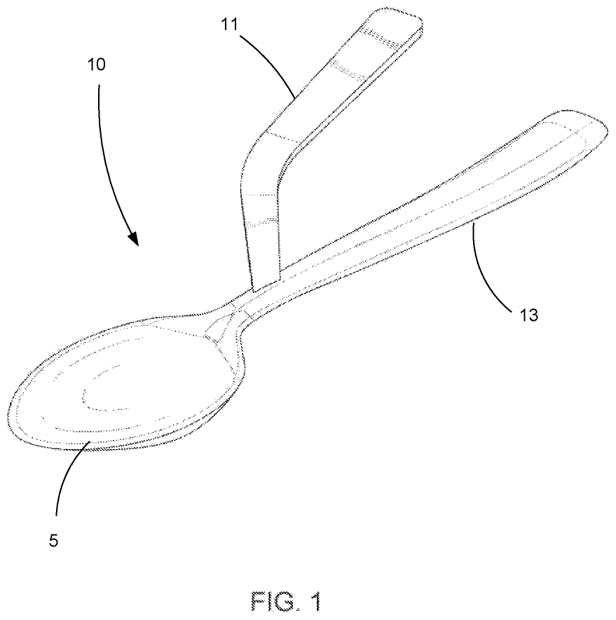

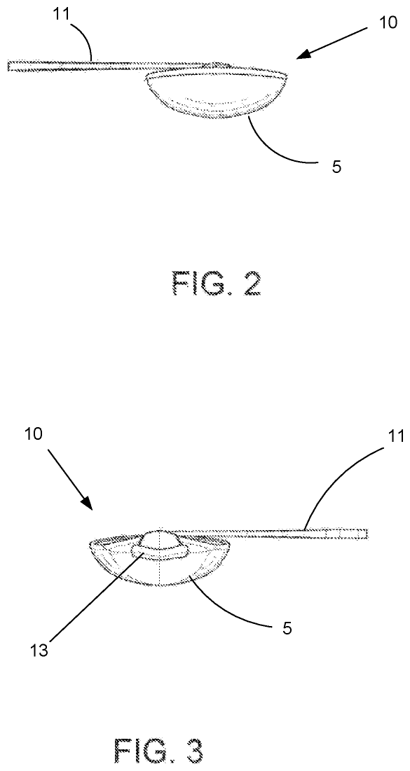

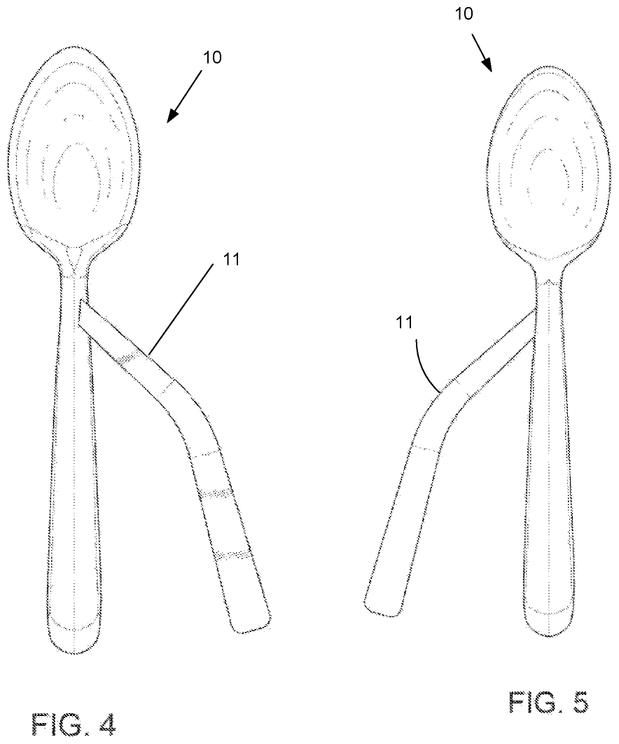

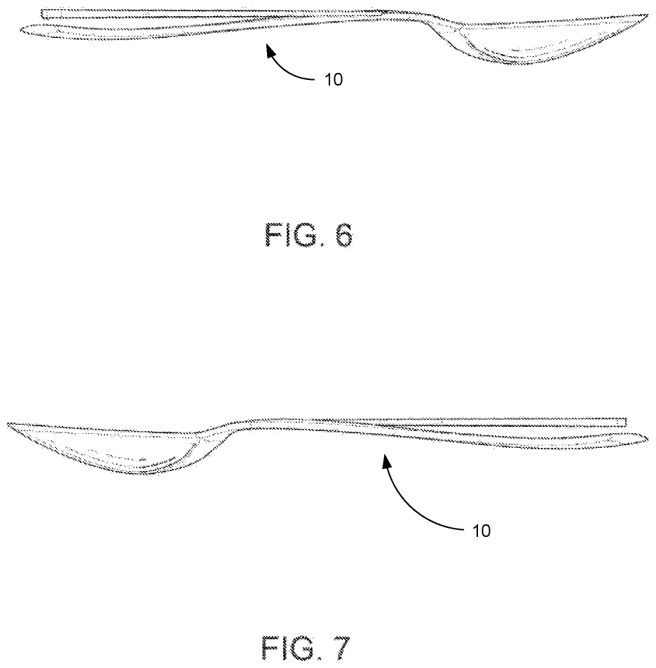

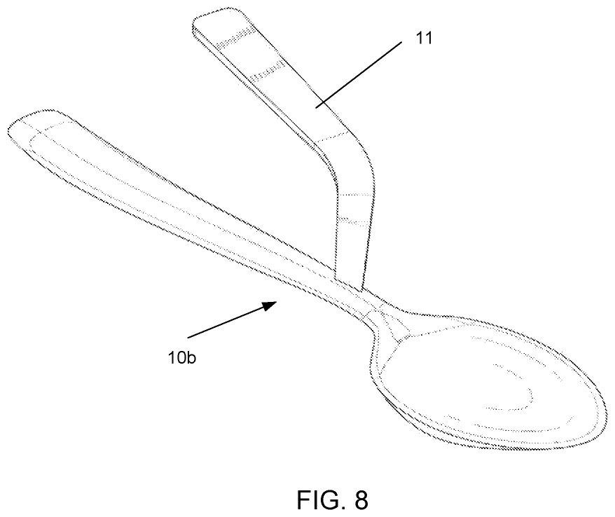

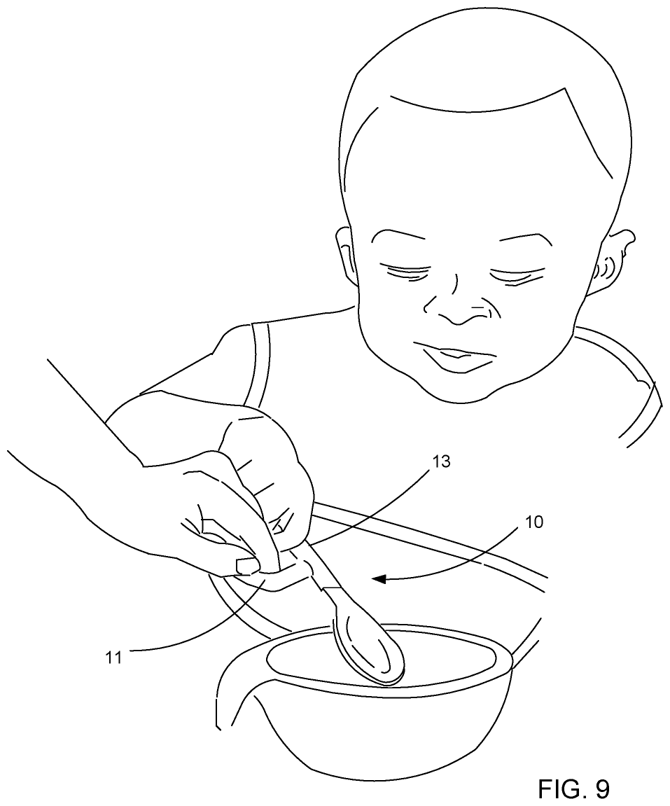

Spoon 10 includes scoop 5, spoon handle 13 and angled handle 11 (FIGS. 1-7). Proper utilization of spoon 10 makes it easy for the spoon user to learn how to properly use a spoon. For example, if the spoon user is a toddler, utilization of spoon 10 will make it easier for the toddler to transition from bottle feeding to spoon feeding. In one embodiment a second person grabs angled handle 11 and helps guide the toddler while the toddler grabs spoon handle 13 (FIG. 8). In another embodiment, the child operates the spoon by himself and allows angled handle 11 to hang on the hand of the child while the child grabs handle 13. This act of hanging improves the toddler's ability to hold and used the spoon, thereby decreasing the time spent learning, stress associated with learning, and mess created during the learning process.

In a preferred embodiment, spoon 10 is fabricated from silicone. Silicone pellets are heated so as to fill the metal mold of the shape of spoon 10. A top portion of the mold is lowered onto a bottom portion and allowed to cool. When cooled, the formed spoon is removed from the mold and packaged as a complete product.

FIG. 8 shows a mother helping her child used right-handed spoon 10. Spoon 10 is right-handed because angled handle 11 is positioned between handle 13 and the person helping the child when the child is grasping spoon 10 in his right hand, allowing for easy access for the person helping the child. In FIG. 8 the mother has grabbed angled handle 11 and is guiding the spoon towards the mouth of the child. By grasping angled handle 11, the mother is able to prevent the child from dropping the spoon and the child is able to learn how to have better control while lifting the spoon towards his mouth without spillage or droppage of the spoon's contents. This encourages the child to learn how to properly use the spoon and makes operation of the spoon more pleasurable and rewarding for both the child and the person helping the child.

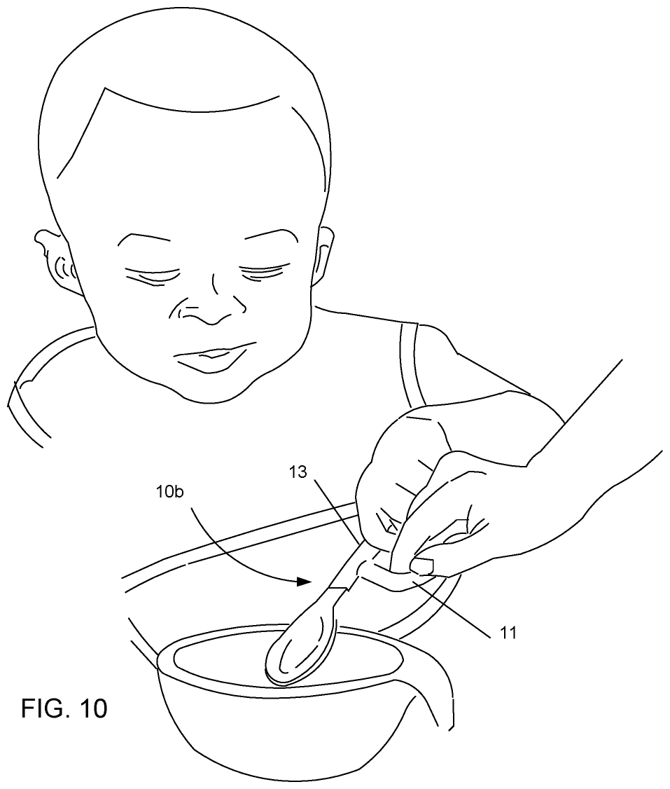

It should be noted that a preferred training spoon may also be made so that it is left-handed. For example, FIG. 8 shows left-handed spoon 10b. FIG. 10 shows the utilization of left-handed spoon 10b. Spoon 10b is left-handed because angled handle 11 is positioned between handle 13 and the person helping the child when the child is grasping spoon 10b in his left hand, allowing for easy access for the person helping the child.

Although the above-preferred embodiments have been described with specificity, persons skilled in this art will recognize that many changes to the specific embodiments disclosed above could be made without departing from the spirit of the invention. For example, although it was stated that spoon 10 is preferably fabricated from silicone, it should be understood that it could also be fabricated from a variety of materials, including plastic or bamboo. Also, although the examples given above show the present invention being utilized to train a toddler how to properly use a spoon, the present invention could also be used to treat other types of people, such as people with disabilities or older people. Therefore, the attached claims and their legal equivalents should determine the scope of the invention.

What is claimed is:

1. A training spoon for training a user how to use a spoon, comprising:
A. a scoop,
B. a straight handle connected to said scoop,
C. an angled handed rigidly connected to said straight handle, wherein said straight handle is grabbable by the user and wherein said angled handle is grabbable by a trainer while assisting the user in the usage of said training spoon.

2. The training spoon as in claim 1 wherein said training spoon is fabricated from silicone.

3. The training spoon as in claim 1 wherein said training spoon is a right-handed training spoon.

4. The training spoon as in claim 1 wherein said training spoon is a left-handed training spoon.

5. A method for using a training spoon comprising the steps of:
A. acquiring a training spoon, said training spoon comprising:
i. a scoop,
ii. a straight handle connected to said scoop,
iii. an angled handle connected to said straight handle,
B. grabbing said straight handle, wherein said grabbing of said straight handle is accomplished by the user,
C. grabbing said angled handle, wherein said grabbing of said angled handle is accomplished by said trainer, and
D. using said spoon to scoop food and direct food to the user's mouth.

6. The method as in claim 5 wherein said training spoon is fabricated from silicone.

7. The method as in claim 5 wherein said training spoon is a right-handed training spoon.

8. The method as in claim 5 wherein said training spoon is a left-handed training spoon.
